(19) United States
(12) Patent Application Publication
(10) Pub. No.: US 2025/0349102 A1
(43) Pub. Date: Nov. 13, 2025

(54) CONVOLUTIONAL NEURAL NETWORK BASED SYSTEM AND METHOD FOR DETECTING A TARGET OBJECT

(71) Applicant: NXP USA, Inc., Austin, TX (US)

(72) Inventors: Yuebin Wang, Jining (CN); Tian Yu, Wuhan City (CN); Cooper Edwin Carnahan, Houston, TX (US); Jianfeng Qin, Shanghai (CN)

(21) Appl. No.: 19/191,763

(22) Filed: Apr. 28, 2025

(30) Foreign Application Priority Data
May 9, 2024 (CN) 202410564879.6

(51) Int. Cl. G06V 10/44; G06N 3/0464; G06V 10/77; G06V 10/82

(52) U.S. Cl. CPC G06V 10/454; G06N 3/0464; G06V 10/7715; G06V 10/82

(57) ABSTRACT

A method for detecting a target object using a convolutional neural network includes: receiving an image frame; producing a first feature map of the image frame; producing a residual feature map from the first feature map by: applying a convolution of a first scale, and thereafter a depth-wise separable convolution, to the first feature map, thereby producing a second feature map; and adding the first feature map and the second feature map to produce an added feature map; producing at least one extracted feature map of the image frame, from the residual feature map by applying additional convolution of a second scale different from the first scale, and thereafter additional depth-wise separable convolution, to the residual feature map; and determining a box using the at least one extracted feature map. The determined box frames the target object.

### BACKGROUND

The present disclosure relates to a method and a system based on lightweight convolutional neural network, and for detecting a target object.

For object detection, especially multiple-object detection, it has been proposed to make use of Convolution-Neural-Network (CNN)-based methods. YOLO (You Only Look Once), SSD (Single Shot multibox Detector), and RetinaNet are known CNN-based solutions for multiple-object detection. Most CNN-based solutions require massive computational power and memory, which is unacceptable for edge devices, for example microcontrollers (MCUs). Most MCUs do not contain accelerators to assist in computing.

### SUMMARY

This summary is provided to introduce a selection of concepts in a simplified form that are further described below in the Detailed Description. This summary is not intended to identify key or essential features of the claimed subject matter, nor is it intended to be used to limit the scope of the claimed subject matter.

In one embodiment, there is disclosed a method for detecting a target object using a convolutional neural network. The method includes: receiving an image frame; producing a first feature map of the image frame; producing a residual feature map from the first feature map by: applying a convolution of a first scale, and thereafter a depth-wise separable convolution, to the first feature map, thereby producing a second feature map; and adding the first feature map and the second feature map to produce an added feature map; producing at least one extracted feature map of the image frame, from the residual feature map by applying additional convolution of a second scale different from the first scale, and thereafter additional depth-wise separable convolution, to the residual feature map; and determining a box using the at least one extracted feature map. The determined box is configured to frame the target object.

In another embodiment, there is disclosed a convolutional neural network based system for detecting a target object. The system includes: a pre-processing unit for receiving an image frame, and producing pre-processed image data using the received image frame; a detection unit for receiving the pre-processed image data, and producing at least one extracted feature map of the image frame; and a post-processing unit for receiving the at least one extracted feature map, and determining a box using the at least one extracted feature map. The determined box is used for framing the target object. The detection unit may include: an initial extraction block for producing a first feature map of the image frame; a residual block for producing a residual feature map from the first feature map by applying a convolution of a first scale, and thereafter a depth-wise separable convolution, to the first feature map, to produce a second feature map, and adding the first feature map and the second feature map to produce an added feature map; and an extraction output block for applying additional convolution of a second scale different from the first scale, and thereafter additional depth-wise separable convolution, to the residual feature map, thereby producing the extracted feature map of the image frame.

### BRIEF DESCRIPTION OF THE DRAWINGS

So that the manner in which the above recited features of the present disclosure can be understood in detail, a more detailed description of the disclosure may be had by reference to embodiments, some of which are illustrated in the appended drawings. The appended drawings illustrate only typical embodiments of the disclosure and should not limit the scope of the disclosure, as the disclosure may have other equally effective embodiments. The drawings are for facilitating an understanding of the disclosure and thus are not necessarily drawn to scale. Advantages of the subject matter claimed will become apparent to those skilled in the art upon reading this description in conjunction with the accompanying drawings, in which like reference numerals have been used to designate like elements, and in which:

FIG. 1 is a block diagram of a system for detecting objects according to an embodiment;

FIG. 2 is a block diagram of the detection unit and the post-processing unit of FIG. 1;

FIG. 3 is a detailed block diagram of the detection unit and the post-processing unit of FIG. 1;

FIG. 4 illustrates operations by the residual block of FIG. 2;

FIG. 5 illustrate operations by the extraction output block of FIG. 2; and

FIG. 6 shows examples of the feature maps and boxes as produced by the system of FIG. 1.

### DETAILED DESCRIPTION

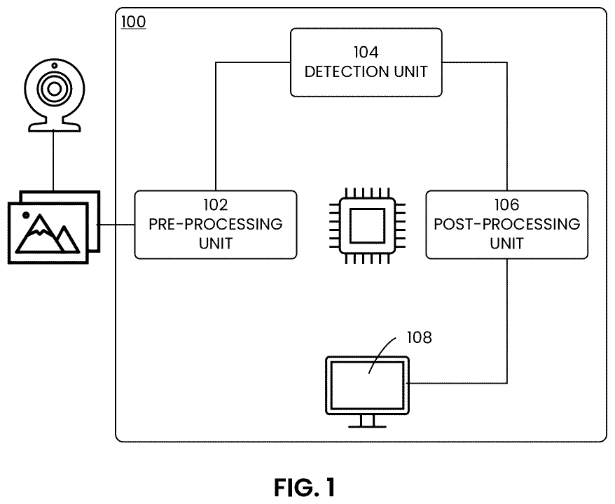

FIG. 1 is a block diagram of a system for detecting objects according to an embodiment. By “detecting objects” is generally meant, hereinunder, identification of the presence, position, and size of one of more instances of a predetermined class or type of object, within an image. Without limitation, such a class of object may be, for example, “hands”, or “faces”. In general, the present disclosure is concerned with detection of one or more instances of the same class of object; however, the disclosure is not limited thereto, and may apply to detection of one or more of one class of object, with one or more of another class, or other classes, of objects.

The system 100 receives image data from an image capturing apparatus, for example a camera, and performs object detection using the received image data. The system 100 includes a pre-processing unit 102, a detection unit 104, and a post-processing unit 106. The pre-processing unit 102 receives the image data, for example image data from a camera in the unit of frames. The image data can be in various formats, for example in a format of YVYU, in which the image is represented by Y, U, and V components, wherein Y is the luminance component, and U and V are chroma components. For subsequent processing, the pre-processing unit 102 converts the image data into RGB888 format, in which the image is represented by R, G, and B components, wherein R is the red component, G is the green component, and B is the blue component, and each of the R, G, and B components is described using an 8-bit data, collectively the RGB888 format. The pre-processing unit 102 may also perform a resizing operation on the received image data, so as to match the input size required by the subsequent detection unit 104. For example, the pre-processing unit 102 may resize the image frame to a predetermined size specified by the subsequent detection unit 104. The pre-processing unit 102 provides pre-processed image data to the detection unit 104.

The detection unit 104 performs object detection using the pre-processed image data supplied from the pre-processing unit 102. In the embodiment, the detection unit 104 is based on lightweight convolutional neural network (CNN). By “lightweight”, is meant that the convolutional neural network used in the detection unit 104 includes a relatively small number of weights, and consumes light computational resources. Typically, the weights are represented in the system through 8-bit bytes. For example, a lightweight CNN-based system for detection of target objects based on the present disclosure may have a total number of weights of less than 220 bytes, i.e ˜1 MB, which is advantageous in implementations in embedded devices, as compared to the CNN-bases systems that typically have weights up to hundreds of Megabytes. Generally, the detection unit 104 performs computations on the pre-processed image data, to extract features of the image frame, and generates feature maps of the image frame. The person skilled in the art of CNN will appreciate that as used herein, a “feature” may not, and in general does not, correspond to a physically, or visually, identifiable concept such as “line” or “edge”. Rather, a feature is a mathematical construct of the CNN process. Based on the produced feature maps, the post-processing unit 106 performs detections of one or more objects of interest. The post-processing unit 106 detects in the feature map from the detection unit 104, each or any object of interest (“target object”), using a fixed detection threshold, and determines a box which will be used for framing the detected target object. Hereinbelow a “box” generally refers to the outline of a shape which is generally rectangular. However, depending on the context, a “box” may refer to the solid shape defined by and within the outline. To be more specific, the post-processing unit 106 determines the box by determining a size and a location of the box based on the feature maps from the detection unit 104. The determined box locates and frames the target object in the image.

According to FIG. 1, the system 100 further includes a display unit 108. The display unit 108 receives data of the determined box, e.g. the central location (cx_{i,j}, Cy_{i,j}) of the box corresponding to the detected object, and the width and height (w_{i,j}, h_{i,j}) of the box corresponding to the target object of interest. The display unit 108 composes the box with the image by locating the box in a position corresponding to the target object, and framing the box around the target object, and displays the determined box outline around the detected object in the image.

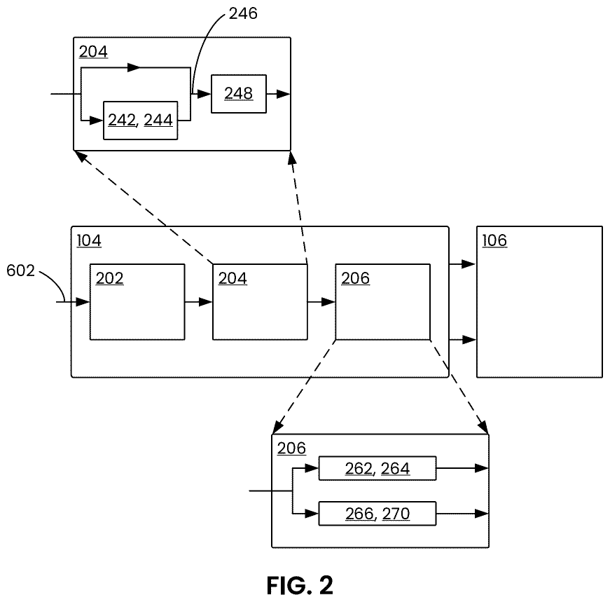

FIG. 2 is a block diagram of the detection unit 104 according to an embodiment. As described above, the detection unit 104 is based on a lightweight convolutional neural network structure. The detection unit 104 includes an initial extraction block 202, a residual block 204, and an extraction output block 206. The initial extraction block 202 receives the pre-processed image data from the pre-processing unit 102, and process it to capture initial features of the input image frame. Generally, the initial extraction block 202 is based on a convolution kernel. The residual block 204 further processes on the initial features of the input frame to narrow down the features, and provides weighted features of the input frame. By “weighted”, it means the features are produced through the convolution by the residual block 204, with weights applied in the convolution. As can be seen from FIG. 2, the residual block 204 is generally convolution-based, and has a residual structure, which will be described hereinafter. The extraction output block 206 generates extracted feature maps of the input image frame based on the weighted features from the residual block 204. In the example shown in FIG. 2, the extraction output block 206 includes a first branch and a second branch, and will be described in further details below.

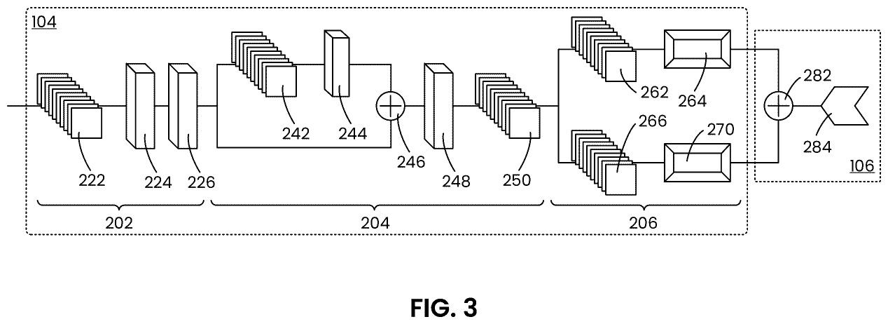

FIG. 3 is a detailed block diagram of the detection unit 104 and the post-processing unit 106 of FIG. 1 and FIG. 2. The initial extraction block 202, which can also be referred to as an initial layer of the detection convolutional neural network structure, utilizes a 3*3 convolution kernel 222 with a stride of 2, to operate computation to the pre-processed image data from the pre-processing unit 102. The 3*3 convolution kernel 222 with the stride of 2 quickly narrows the feature map of the image frame, and is advantageous by, in the beginning of the process, reducing the required number of computations, and reducing the memory consumption, for example the RAM consumption, compared with other configurations, such as convolution kernels with smaller sizes or less strides. The initial extraction block 202 then includes a first depth-wise separable convolution layer 224 and a second depth-wise separable convolution layer 226, each having a stride of 1, to capture initial features of the input frame, and produce a first feature map as an output.

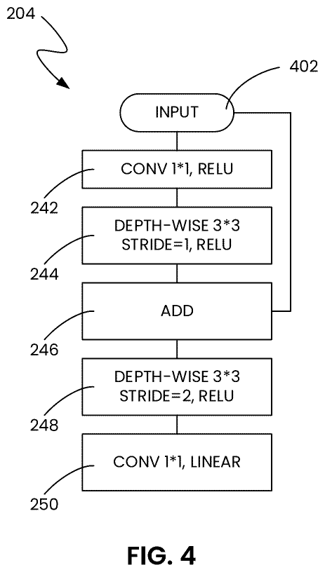

Refer now to FIG. 4 which is a flow diagram of the operations performed by the residual block 204 according to the embodiment. The flow of FIG. 4 will be described with reference to FIG. 2 and FIG. 3. The input 402 to the residual block is typically the output from second depth-wise separable convolution layer 226. Examples of the residual block 204 are built using a residual structure which includes a first convolution layer 242, a third depth-wise separable convolution layer 244, and an adder 246, followed by a fourth depth-wise separable convolution layer 248 and a second convolution layer 250. According to the embodiment, the first convolution layer 242 is a 1*1 convolution kernel, and the third depth-wise convolution layer 244 is a separable convolution layer. The first convolution layer 242, together with the third depth-wise convolution layer 244, forms a first branch of convolution which filters the features out from the first feature map of the image frame provided by the initial extraction block 202, and provides a second feature map as the input to the adder 246. The adder 246 receives the second feature map from the third depth-wise convolution layer 244, and receives the first feature map directly from the second depth-wise convolution layer 226 of the initial extraction block 202. In other words, the adder 246 receives the output of the first branch of convolution consisting the first convolution layer 242 and the third depth-wise convolution layer 244, and receives the input to the first branch of convolution, and adds the first feature map and the second feature map together, to produce an added feature map. As mentioned above, it is understood that, an example of a feature map is represented by a matrix of values obtained through the convolution operations on the image frame. By “adding” the feature map it means to create the added feature map with a matrix of values, and each value is a sum of values from a corresponding position of the first and second feature maps. Connection of the input and output of the first branch of convolution through the adder 246 helps in keeping useful information in the image frame that may have been lost by the first branch of convolution.

Because of the connection by the adder 246, the produced added feature map from the adder 246 keeps a resolution equal to that of the feature map from the second depth-wise separable convolution layer 226 of the initial extraction block 202. The added feature map output from the adder 246 is further narrowed down by the fourth depth-wise convolution layer 248 and the second convolution layer 250. FIG. 4 shows operations to the added feature map by the fourth depth-wise convolution layer 248 and the second convolution layer 250. The fourth depth-wise convolution layer 248 performs a 3*3 depth-wise convolution to the input added feature map, with a stride of 2. The second convolution layer 250 further performs a 1*1 convolution on an output of the fourth depth-wise convolution layer 248. The skilled person will appreciate that the present disclosure is not limited to any one specific type of convolution layer. Without limitation, examples of the first convolution layer 242 and the third depth-wise convolution layer 244, that may be employed according to embodiment of the present disclosure, include Rectified Linear Unit (ReLU) as the activation layer after the convolution. ReLU is typically a non-linear function which imitates non-linear behaviors in nature, for example the information encoding of biological neurons is usually scattered and sparse. Examples of the fourth depth-wise convolution kernel 248 also include ReLU as the activation layer. Examples of the second convolution kernel 250 include linear activation layers.

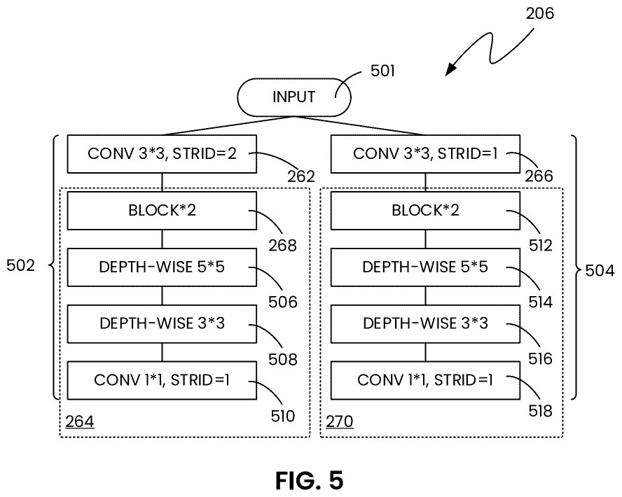

The residual feature map produced by the residual block 204 is fed into the extraction output block 206 as an input 501, to produce a final output of the feature maps. In an example, the extraction output block 206 is built up as a multiscale structure, which includes at least one output branch and, as illustrated in the example of FIG. 2 with also reference to FIG. 5, a first output branch 502 and a second output branch 504 that are similar to each other, except that they may have different strides. By “multiscale” it is to mean the kernels and strides for convolutions have different sizes from each other. Examples of the extraction output block 206 may include more branches, for facilitating detection of more sized objects.

Taking the first output branch 502 as an example, there includes a convolution kernel 262 having a size of 3*3 and a stride of 2, and a multiscale kernel 264 part of which includes convolution layers similar to the first branch of convolution of the residual block 204. Convolution kernels of the other output branches of the extraction output block 206 may have different strides, for example the convolution kernel 266 of the second branch 504 as shown in FIG. 2 and FIG. 5 has a stride of 1. It can be understood that the convolution kernel with the stride of 2 is helpful in filtering the features of large objects, and the convolution kernel with the stride of 1 is helpful in filtering the features of relatively small objects.

FIG. 5 illustrates a flow diagram of the processes of the extraction output block 206 of FIG. 2 and FIG. 3. Output of the convolution kernel 262 is provided to a block 268 of the multiscale kernel 264. As described, the block 268 is similar to the first branch of convolution of the residual block 204 as illustrated in FIG. 2 and FIG. 3, and includes a convolution kernel and a depth-wise convolution kernel. The multiscale kernel 264 includes at least one block 268. Examples of the multiscale kernel 264 include two sequentially connected blocks 268 (shown as “BLOCK*2” in each branch of FIG. 5). Output of the at least one block 268 is provided to following layers that include, in sequence, a depth-wise 5*5 convolution layer 506, a depth-wise 3*3 convolution layer 508, and a 1*1 convolution layer 510 with a stride of 1. Similarly, the multiscale kernel 270 of the second output branch 504 includes at least one block 512. Examples of the multiscale kernel 270 include two sequentially connected blocks 512 (shown as “BLOCK*2” in each branch of FIG. 5). Output of the at least one block 512 is provided to following layers that include, in sequence, a depth-wise 5*5 convolution layer 514, a depth-wise 3*3 convolution layer 516, and a 1*1 convolution layer 518 with a stride of 1. Multiple examples of the branches of the extraction output block have different sizes or multiscale sizes, which is advantageous in locating the objects more precisely.

Outputs of both branches 502 and 504 of the extraction output block 206 are provided to the post-processing unit 106. Referring to FIG. 3, an example of the post-processing unit 106 includes a box extraction unit 282 and a box output unit 284. The box extraction unit 282 receives the feature maps from the branches of the extraction output block 206 of the detection unit 104, and determines candidate boxes basing on the feature maps that have been derived through convolutions to the original image frame. The box output unit 284 determines final boxes from the candidate boxes, and outputs the determined final box.

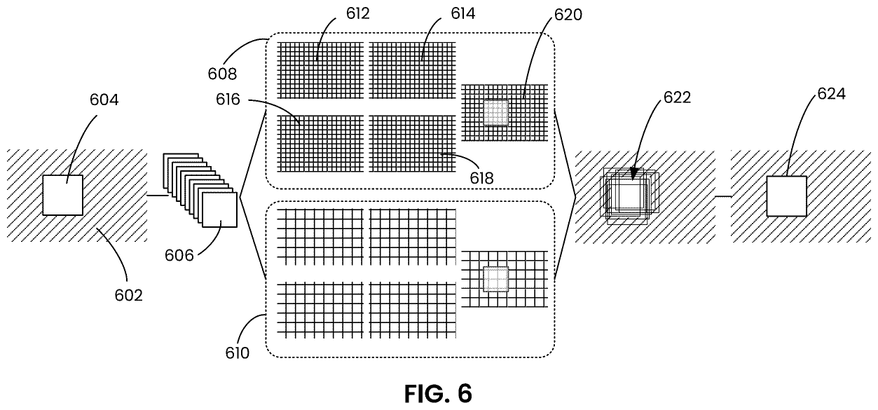

FIG. 6 shows an example of derivatives during a flow of the operations from the original image to the determined final box. Take the system 100 of FIG. 1 as an example, the image frame 602 from the pre-processing unit 102 includes a target object 604 which is the object of interest to the system. The image frame 602 is processed through a convolution network 606, for which the detection unit 104 of FIG. 1 to FIG. 3 may be an example. As shown in FIG. 6, each of the feature maps 608 and 610 output by the corresponding branch is represented by 5 channels, respectively the central locations cx 612 and cy 614, the width w 616, the height h 618, and the confidence value 620. Because the convolution kernels of the branches have different scales, the resolutions of feature maps from the branches are different, as in FIG. 6 the feature resolution of branch 608 is 2 times the feature resolution of branch 610.

Basing on the feature maps 608 and 610 from the branches, the box extraction unit 282 determines the candidate boxes 622 through a fixed threshold detection. As an example and in more details, a “candidate box” is determined based on the confidence value 620 in the confidence value channel, and specifically based on whether the confidence value 620 is higher than a detection threshold. In some embodiments, the detection threshold is fixed, and predetermined. In other embodiments, the threshold value is set, based on the application for which the detection system is used.

As described above, a candidate box 622 has the features of the location coordinates and the sizes. In the case that a confidence value 620 is higher than the threshold, the associated box (defined by the remaining four channels being its centre-coodinates, height and width) is determined, and provided as a “candidate box”. Further, the box output unit 284 filters the candidate boxes 622 through a selection filter, for example Non-Maximum Suppression (NMS), and decides a final box 624 for the object to be detected. NMS is used for removing the duplicate boxes and keeping the most relevant box. Without limitation, in the embodiment shown, NMS is typically implemented by iterating the steps of: selecting the box with a maximum confidence value score as a seed box, calculating IoU (Intersection over Union) values of the seed box and other boxes, and discarding boxes with IoUs lower than an NMS threshold, while replacing the seed box with the box corresponding to the highest IoU. IoU means the intersecting area of the boxes over the union area of the boxes. An example value of the NMS threshold is 0.5.

In an example, the detection unit 104 includes multiple depth-wise separable convolution kernels, for example the first depth-wise convolution layer 224, the second depth-wise convolution layer 226, the third depth-wise convolution layer 244, the fourth depth-wise convolution layer 248, and the 5*5 and 3*3 depth-wise convolutions of the multiscale kernels 264, so to produce fewer weights than standard convolutions that usually use weight matrixes, and is helpful in reducing ROM (Read-Only Memory) or RAM (Random-Access Memory) consumption in the detection unit 104. As a reference, a traditional 8-input-16-output-channel convolution has a weight size of 16*8*3*3=1152, while the depth-wise convolution with the same input and output channel numbers produces only 8*3*3+1*1*8*16=200 weights. Reducing ROM or RAM consumption is particularly useful for embedded devices, on which the multiple object detection may thus become efficient, and consume reduced computing resources.

In training the detection unit 104, the weights are constrained by a loss function:

$$loss = {\sum }_{i = 0}^{SH} {\sum }_{j = 0}^{SW} {I}_{i , j}^{obj} [ {( {cx}_{i , j} - {i , j}_{} )}^{2} + {( {cy}_{i , j} - {i , j}_{} )}^{2} ] + {\sum }_{i = 0}^{SH} {\sum }_{j = 0}^{SW} {I}_{i , j}^{obj} [ {( {w}_{i , j} - {\hat{w}}_{i , j} )}^{2} + {( {h}_{i , j} - {\hat{h}}_{i , j} )}^{2} ] + {\sum }_{i = 0}^{SH} {\sum }_{j = 0}^{SW} {{I}_{i , j}^{obj} ( {conf}_{i , j} - )}^{2} + {\sum }_{i = 0}^{SH} {\sum }_{j = 0}^{SW} {{I}_{i , j}^{noobj} ( {conf}_{i , j} - )}^{2} ,$$

wherein SH and SW correspond to the height and width of the output feature map

$${I}_{i , j}^{obj}$$

denotes if the objects appear in the corresponding cell,

$${I}_{i , j}^{noobj}$$

denotes the objects do not appear in the corresponding cell, (cx_{i,j}, Cy_{i,j}) is the true value of the central location of the objects, (W_{i,j}, h_{i,j}) is the true value of the width and height of the objects, conf_{i,j} represents the confidence value that an object is in the corresponding cell, and \hat{⋅} denotes the prediction values from the feature maps in the network. Using the loss function, precision in locating the object is improved. The loss function is also able to provide a classification to the object area and non-object area.

As described above, ReLU layers follow the convolutions to produce more representative characteristics. ReLU-type layers are advantageous because the 8-bit quantization loss is relatively low, compared to other activation layer types, for example PRELU layers. As is known, the ReLU activation layer has no quantization loss when the activated values are negative.

Thus, one aspect of the present disclosure comprises receiving an image frame 602; producing 202 a first feature map 608 of the image frame; producing 204 a residual feature map from the first feature map by: applying a convolution 242 of a first scale, and thereafter a depth-wise separable convolution 244, to the first feature map, thereby producing a second feature map; and adding 246 the first feature map and the second feature map to produce an added feature map; producing 206 at least one extracted feature map of the image frame, from the residual feature map by applying additional convolution 262 of a second scale different from the first scale, and thereafter additional depth-wise separable convolution 264, to the residual feature map; and determining 106 a box using the at least one extracted feature map, wherein the determined box 624 is configured to frame the target object 604.

Another aspect of the present disclosure comprises a convolutional neural network based system configured to detect a target object. The system includes a pre-processing unit 102 configured to receive an image frame 602, and produce pre-processed image data using the received image frame; a detection unit 104 configured to receive the pre-processed image data, and produce at least one extracted feature map of the image frame; and a post-processing unit 106 configured to receive the at least one extracted feature map, and determine a box 624 using the at least one extracted feature map. The determined box 624 is configured to frame the target object 604. The detection unit 104 includes: an initial extraction block 202 configured to produce a first feature map of the image frame; a residual block 204 configured to produce a residual feature map from the first feature map by: applying a convolution 242 of a first scale, and thereafter a depth-wise separable convolution 244, to the first feature map, to produce a second feature map, and adding 246 the first feature map and the second feature map to produce an added feature map; and an extraction output block 206 configured to apply additional convolution 262 of a second scale different from the first scale, and thereafter additional depth-wise separable convolution 264, to the residual feature map, thereby producing the extracted feature map of the image frame.

It is now understood that, examples of the system includes ultra-lightweight neural network with residual structure for multiple objection detection, to reduce the use of memory and the computation, and is very suitable for applications in embedded devices, for example Microcontroller Units (MCU), with improved performance that can detect up to 5 frames every second on a 1-GHz ARM® Cortex-M7 microcontroller.

The use of the terms “a” and “an” and “the” and similar referents in the context of describing the subject matter (particularly in the context of the following claims) are to be construed to cover both the singular and the plural, unless otherwise indicated herein or clearly contradicted by context. The terms “coupled” and “connected” both mean that there is an electrical connection between the elements being coupled or connected, and neither implies that there are no intervening elements. Recitation of ranges of values herein are intended merely to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the disclosure as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. A method for detecting a target object using a convolutional neural network, comprising:
receiving an image frame;
producing a first feature map of the image frame;
producing a residual feature map from the first feature map by:
applying a convolution of a first scale, and thereafter a depth-wise separable convolution, to the first feature map, thereby producing a second feature map; and
adding the first feature map and the second feature map to produce an added feature map;
producing at least one extracted feature map of the image frame, from the residual feature map by applying additional convolution of a second scale different from the first scale, and thereafter additional depth-wise separable convolution, to the residual feature map; and
determining a box using the at least one extracted feature map, wherein the determined box is configured to frame the target object.

2. The method of claim 1, wherein producing the first feature map of the image frame comprises: applying a convolution of the second scale, and thereafter at least a depth-wise separable convolution, to the image frame.

3. The method of claim 1, further comprising applying a depth-wise separable convolution with a scale of 3*3 and a stride of 2, and a subsequent 1*1 convolution with a linear activation layer, to the added feature map, to produce the residual feature map.

4. The method of claim 1, wherein applying additional convolution and thereafter additional depth-wise separable convolution to the residual feature map comprises:
feeding the residual feature map as an input into a first convolution branch and a second convolution branch;
producing a first branch feature map by the first convolution branch using the residual feature map; and
producing a second branch feature map by the second convolution branch using the residual feature map.

5. The method of claim 4, wherein the first convolution branch comprises:
a convolution layer with a scale of 3*3 and a stride of 2;
at least one convolution block comprising a convolution layer with a scale of 1*1 and a depth-wise separable convolution layer with a scale of 3*3 and a stride of 1;
a depth-wise separable convolution layer with a scale of 5*5;
a depth-wise separable convolution layer with a scale of 3*3; and
a convolution layer with a scale of 1*1 and a stride of 1.

6. The method of claim 5, wherein the first convolution branch comprises two convolution blocks.

7. The method of claim 4, wherein the second convolution branch comprises:
a convolution layer with a scale of 3*3 and a stride of 1;
at least one convolution block comprising a convolution layer with a scale of 1*1 and a depth-wise separable convolution layer with a scale of 3*3 and a stride of 1;
a depth-wise separable convolution layer with a scale of 5*5;
a depth-wise separable convolution layer with a scale of 3*3; and
a convolution layer with a scale of 1*1 and a stride of 1.

8. The method of claim 7, wherein the second convolution branch comprises two convolution blocks.

9. The method of claim 1, wherein determining the box using the extracted feature map comprises:
determining candidate boxes using the extracted feature map, wherein each of the candidate boxes is corresponding to a confidence value higher than a detection threshold; and
determining a final box from the candidate boxes through Non-Maximum Suppression.

10. The method of claim 9, wherein the extracted feature map comprises a first channel of confidence value, a second channel of horizontal coordinates of central location prediction, a third channel of vertical coordinates of central location prediction, a fourth channel of width prediction, and a fifth channel of height prediction; and wherein determining the candidate boxes comprises:
determining a confidence value of the first channel of the extracted feature map is higher than the detection threshold;
determining the candidate box as being positioned at a central location with a corresponding horizontal coordinate of the second channel and a corresponding vertical coordinate of the third channel; and
determining the candidate box as having a width of the corresponding width of the fourth channel and a height of the corresponding height of the fifth channel.

11. A convolutional neural network based system configured to detect a target object comprising:
a pre-processing unit configured to receive an image frame, and produce pre-processed image data using the received image frame;
a detection unit configured to receive the pre-processed image data, and produce at least one extracted feature map of the image frame; and
a post-processing unit configured to receive the at least one extracted feature map, and determine a box using the at least one extracted feature map, wherein the determined box is configured to frame the target object; wherein
the detection unit comprises:
an initial extraction block configured to produce a first feature map of the image frame;
a residual block configured to produce a residual feature map from the first feature map by: applying a convolution of a first scale, and thereafter a depth-wise separable convolution, to the first feature map, to produce a second feature map, and adding the first feature map and the second feature map to produce an added feature map; and
an extraction output block configured to apply additional convolution of a second scale different from the first scale, and thereafter additional depth-wise separable convolution, to the residual feature map, thereby producing the extracted feature map of the image frame.

12. The system of claim 11, wherein the initial extraction block is configured to apply a convolution of the second scale, and thereafter at least a depth-wise separable convolution, to the image frame, to produce the first feature map of the image frame.

13. The system of claim 11, wherein the residual block is further configured to apply a depth-wise separable convolution with a scale of 3*3 and a stride of 2, and a subsequent 1*1 convolution with a linear activation layer, to the added feature map, to produce the residual feature map.

14. The system of claim 11, wherein
the extraction output block comprises a first convolution branch and a second convolution branch; and wherein
the extraction output block is configured to apply the additional convolution and thereafter the additional depth-wise separable convolution to the residual feature map, after the residual block feeding the residual feature map as an input into the first convolution branch and the second convolution branch;
wherein the first convolution branch is configured to produce a first branch feature map using the residual feature map; and
wherein the second convolution branch is configured to produce a second branch feature map using the residual feature map.

15. The system of claim 14, wherein the first convolution branch comprises:
a convolution layer with a scale of 3*3 and a stride of 2;
at least one convolution block comprising a convolution layer with a scale of 1*1 and a depth-wise separable convolution layer with a scale of 3*3 and a stride of 1;
a depth-wise separable convolution layer with a scale of 5*5;
a depth-wise separable convolution layer with a scale of 3*3; and
a convolution layer with a scale of 1*1 and a stride of 1.

16. The system of claim 15, wherein the first convolution branch comprises two convolution blocks.

17. The system of claim 14, wherein the second convolution branch comprises:
a convolution layer with a scale of 3*3 and a stride of 1;
at least one convolution block comprising a convolution layer with a scale of 1*1 and a depth-wise separable convolution layer with a scale of 3*3 and a stride of 1;
a depth-wise separable convolution layer with a scale of 5*5;
a depth-wise separable convolution layer with a scale of 3*3; and
a convolution layer with a scale of 1*1 and a stride of 1.

18. The system of claim 17, wherein the second convolution branch comprises two convolution blocks.

19. The system of claim 11, wherein
the post-processing unit comprises a box extraction unit and a box output unit, and wherein
the box extraction unit is configured to determine candidate boxes using the extracted feature map, wherein each of the candidate boxes is corresponding to a confidence value higher than a detection threshold; and
the box output unit is configured to determine a final box from the candidate boxes through Non-Maximum Suppression.

20. The system of claim 19, wherein the extracted feature map comprises a first channel of confidence value, a second channel of horizontal coordinates of central location prediction, a third channel of vertical coordinates of central location prediction, a fourth channel of width prediction, and a fifth channel of height prediction; and wherein the box extraction unit is configured to:
determine a confidence value of the first channel of the extracted feature map is higher than the detection threshold;
determine the candidate box as being positioned at a central location with a corresponding horizontal coordinate of the second channel and a corresponding vertical coordinate of the third channel; and
determine the candidate box as having a width of the corresponding width of the fourth channel and a height of the corresponding height of the fifth channel.
